(19) United States
(12) Patent Application Publication
(10) Pub. No.: US 2023/0079042 A1
(43) Pub. Date: Mar. 16, 2023

(54) DISPLAY FOR A HYPER REALISTIC DRIVE SIMULATION

(71) Applicant: Sony Group Corporation, Tokyo (JP)

(72) Inventors: Ted Yamazaki, San Diego, CA (US); Tonni Sandager Larsen, San Diego, CA (US)

(73) Assignee: Sony Group Corporation, Tokyo (JP)

(21) Appl. No.: 17/477,377

(22) Filed: Sep. 16, 2021

(51) Int. Cl. G09B 9/05; G06F 3/01; G09B 9/042; G06F 1/16

(52) U.S. Cl. CPC G09B 9/05; G06F 3/011; G09B 9/042; G06F 1/1637; A63G 31/16

(57) ABSTRACT

Implementations generally relate to providing a hyper realistic simulated driving experience. In some implementations, a method includes monitoring, at a media unit, user interaction with vehicle controls of a vehicle, wherein the media unit is configured to provide visual feedback to a user. The method further includes generating a simulated driving experience based on the user interaction with the vehicle controls and based on simulated road conditions. The method further includes displaying the visual feedback on the display, wherein the display is configured to be stored in a frunk of the vehicle when the display is in a retracted position, and wherein the display is configured to be positioned in front of a user when the display is in a protracted position. The method further includes controlling motion of the vehicle based on the vehicle control input and the simulated road conditions.

### CROSS REFERENCES TO RELATED APPLICATIONS

This application is related to the following applications, U.S. patent application Ser. No. 17/477,375, entitled HYPER REALISTIC DRIVE SIMULATION, filed on Sep. 16, 2021 (020699-119200US/SYP340051US01), which is hereby incorporated by reference as if set forth in full in this application for all purposes.

### BACKGROUND

Drive simulators for consumer use have traditionally been based on gaming systems where audio/visuals are software renderings of pre-programmed tracks. For advanced systems, a gaming chair may emulate road conditions, turns etc. The pre-programmed tracks may be limited, and a given user needs to find room inside the house for the gaming chair.

### SUMMARY

Implementations generally relate to a system that provides a hyper realistic simulated driving experience. In some implementations, a system includes a display, wherein the display is configured to be stored in a frunk of a vehicle when the display is in a retracted position, and wherein the display is configured to be positioned in front of a user when the display is in a protracted position; and a media unit, wherein the media unit is configured to provide visual feedback to the user via the display.

With further regard to the system, in some implementations, the display is positioned inside a cab of the vehicle when the display is in the protracted position. In some implementations, the display is positioned outside a cab of the vehicle when the display is in the protracted position. In some implementations, the display expands when the display is in the protracted position such that a width of the display is greater than a front windshield of the vehicle. In some implementations, the display expands when the display is in the protracted position such that a height of the display is adjustable. In some implementations, the display is attached to a front hood of the vehicle when the display is in the retracted position and in the protracted position. In some implementations, the display is configurable to rotate when the display is in the protracted position.

In some implementations, an apparatus includes a display, wherein the display is configured to be stored in a frunk of a vehicle when the display is in a retracted position, and wherein the display is configured to be positioned in front of a user when the display is in a protracted position; and a media unit, wherein the media unit is configured to provide visual feedback to the user via the display.

With further regard to the apparatus, in some implementations, the display is positioned inside a cab of the vehicle when the display is in the protracted position. In some implementations, the display is positioned outside a cab of the vehicle when the display is in the protracted position. In some implementations, the display expands when the display is in the protracted position such that a width of the display is greater than a front windshield of the vehicle. In some implementations, the display expands when the display is in the protracted position such that a height of the display is adjustable. In some implementations, the display is attached to a front hood of the vehicle when the display is in the retracted position and in the protracted position. In some implementations, the display is configurable to rotate when the display is in the protracted position.

In some implementations, a method includes: monitoring, at a media unit, user interaction with vehicle controls of a vehicle, wherein the media unit is configured to provide visual feedback to a user; generating a simulated driving experience based on the user interaction with the vehicle controls and based on simulated road conditions; displaying the visual feedback on the display, wherein the display is configured to be stored in a frunk of the vehicle when the display is in a retracted position, and wherein the display is configured to be positioned in front of a user when the display is in a protracted position; and controlling motion of the vehicle based on the vehicle control input and the simulated road conditions.

With further regard to the method, in some implementations, the display is positioned inside a cab of the vehicle when the display is in the protracted position. In some implementations, the display is positioned outside a cab of the vehicle when the display is in the protracted position. In some implementations, the display expands when the display is in the protracted position such that a width of the display is greater than a front windshield of the vehicle. In some implementations, the display expands when the display is in the protracted position such that a height of the display is adjustable. In some implementations, the display is attached to a front hood of the vehicle when the display is in the retracted position and in the protracted position.

A further understanding of the nature and the advantages of particular implementations disclosed herein may be realized by reference of the remaining portions of the specification and the attached drawings.

### BRIEF DESCRIPTION OF THE DRAWINGS

FIG. 1 is a block diagram of an example simulation environment for providing a hyper realistic drive simulation, which may be used for implementations described herein.

FIG. 2 is a block diagram of an example simulation environment for providing a hyper realistic drive simulation, which may be used for implementations described herein.

FIG. 3 is a block diagram of an example simulation environment for providing a hyper realistic drive simulation, which may be used for implementations described herein.

FIG. 4 is an example flow diagram for providing a hyper realistic drive simulation, according to some implementations.

FIG. 5 is a side-view diagram showing example states of a frunk display, according to some implementations.

FIG. 6 is a top-view diagram showing example states of the frunk display of FIG. 5, according to some implementations.

FIG. 7 is a perspective-view diagram showing example states of the frunk display of FIGS. 5 and 6, according to some implementations.

FIG. 8 is a side-view diagram showing example states of a frunk display, according to some implementations.

FIG. 9 is a top-view diagram showing example states of the frunk display of FIG. 8, according to some implementations.

FIG. 10 is a perspective-view diagram showing example states of the frunk display of FIGS. 8 and 9, according to some implementations.

FIG. 11 is a side-view diagram showing example states of a frunk display, according to some implementations.

FIG. 12 is a diagram showing the frunk display of FIG. 11 from a perspective of a user inside the cab of a vehicle, where the frunk display is at a ⅓ height, according to some implementations.

FIG. 13 is a diagram showing the frunk display of FIGS. 11 and 12 from a perspective of a user inside the cab of a vehicle, where the frunk display is at a ½ height, according to some implementations.

FIG. 14 is a diagram showing the frunk display of FIGS. 11, 12, and 13 from a perspective of a user inside the cab of a vehicle, where the frunk display is at a full height, according to some implementations.

FIG. 15 is a diagram showing the frunk display of FIG. 11 from a perspective of a user inside the cab of a vehicle, where the frunk display is at a ⅓ height, and where different portions of the frunk display may serve different purposes, according to some implementations.

FIG. 16 is a side-view diagram showing example states of a frunk display, according to some implementations.

FIG. 17 is a top-view diagram showing example states of a frunk display, according to some implementations.

FIG. 18 is a diagram showing example components of a vehicle, according to some implementations.

FIG. 19 is a diagram showing example orientations a frunk display, according to some implementations.

FIG. 20 is a diagram showing example changes to content shown on a frunk display, according to some implementations.

FIG. 21 is a block diagram of an example network environment, which may be used for some implementations described herein.

FIG. 22 is a block diagram of an example computer system, which may be used for some implementations described herein.

### DETAILED DESCRIPTION

Implementations described herein provide a hyper realistic simulated driving experience for drivers. Implementations improve driving safety by enabling personalization and realistic drive simulation in an actual vehicle while the car is parked.

As described in more detail herein, in various implementations, a system monitors, at a media unit, user interaction with vehicle controls of a vehicle, wherein the media unit is configured to provide visual feedback to a user. The system further generates a simulated driving experience based on the user interaction with the vehicle controls and based on simulated road conditions. The system further displays the visual feedback on the display, where the display is configured to be stored in a frunk of the vehicle when the display is in a retracted position, and where the display is configured to be positioned in front of a user when the display is in a protracted position. The system further controls motion of the vehicle based on the vehicle control input and the simulated road conditions.

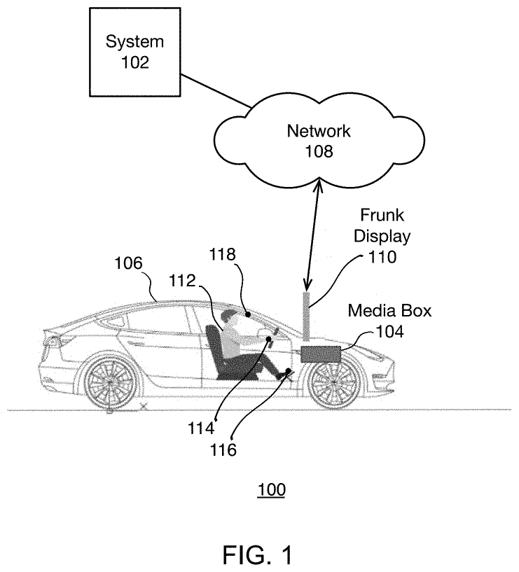

FIG. 1 is a block diagram of an example simulation environment 100 for providing a hyper realistic drive simulation, which may be used for implementations described herein. In various implementations, simulation environment 100 includes a system 102, which communicates with a media device or media box 104 of a vehicle 106. In various implementations, media box 104 may be implemented as an in-vehicle infotainment (IVI) system. In various implementations, media box 104 may operate with a head unit (H/U). In some implementations, the H/U may be worn regardless the original equipment manufacturer (OEM), installer, user, etc. Media box 104 is configured to be stored in the frunk of vehicle 106. A frunk may be defined as a storage space or trunk that is positioned in the front of a vehicle rather than in the rear of the vehicle. Frunks are common in vehicles such as electric vehicles, which do not typically have an engine under the front hood. In various implementations, media box 104 is not limited to storage in the frunk and alternatively may be positioned anywhere in the vehicle. In some implementations, media box 104 be integrated with a frunk display.

System 102 communicates with media box 104 via a network 108. Network 108 may be any suitable communication network or combination of networks such as a Bluetooth network, a Wi-Fi network, the Internet, a 5G or 6G+ network, a satellite constellation network, etc. Also shown is a frunk display 110 positioned in front of a user 112 seated in vehicle 106.

In various implementations, frunk display 110 is configured to be stored in the frunk of vehicle 106 when frunk display 110 is in a retracted position. Frunk display 110 is also configured to be positioned in front of a user when the display is in a protracted position.

In various implementations, the display is positioned outside a cab of the vehicle when the display is in the protracted position. This eliminates a need for the display to take up space in the cabin of the vehicle, thereby eliminating unnecessary disruption or disturbance in the cabin. Also, by being located on the exterior of the vehicle and in front of the front windshield of the vehicle, the system may present a more realistic representation of the virtual scenery, including any virtual road or track. Being located on the exterior also allows for a bigger display, which is better for the eyes. Being located on the exterior also facilitates the system in matching real and virtual cognition information.

Alternatively, in some implementations, a display may be positioned inside the cab of the vehicle when the display is in the protracted position. While being positioned on the exterior is optimal, being positioned on the interior may be useful in some scenarios. For example, in some implementations, the display may be positioned just inside the front windshield. In some implementations, one or more displays may be positioned in front of rear passengers (e.g., attached to the back of the drivers seat and/or to the back of the front passenger seat or attached to the ceiling of the vehicle, etc.). In yet another example implementation, a display device including a projector may be used.

In various implementations, system 102 may send or downstream simulation data to media box 104 and/or to an IVI H/U associated with media box 104. Also, system 102 may receive or upstream behavior analytics data including UI data, sensor data, video data, audio data, and metadata from media box 104. System 102 presents visual driving information to user 112 via frunk display 110. For example, system 102 may send a video stream to frunk display 110 directly or via media box 104. In various implementations, the video stream contains audio, video, and metadata. The video stream utilizes the audio, video, and metadata to show virtual scenery as vehicle 106 virtually travels along a driving route or driving track. The terms driving route, driving track, and track may be used interchangeably.

As described in more detail herein, in various implementations, the system may track environmental information (e.g., roads/tracks, road conditions, etc.), behavior of user, vehicle performance, and other associated information while the user operates the vehicle during normal, real-world driving on an actual road. In various implementations described herein, the system monitors and stores such information for future simulated driving experiences.

In various implementations, during simulated driving experiences, the vehicle remains parked. The system may decouple the wheels of the vehicle such that the vehicle remains parked regardless of the vehicle control input provided by the user (e.g., stepping on the accelerator, etc.). During simulated driving experiences, the system monitors the behavior of user, including movements of the user and information associated with vehicle controls manipulated by the user.

Referring still to FIG. 1, as shown, simulation environment 100 includes in-cabin sensors 114, 116, and 118. In various implementations, the system utilizes sensors 114, 116, and 118 to monitor the behavior and actions of the user. In the example implementation shown, sensors 114 and 116 are electromyography (EMG) sensors, and sensor 118 is an image sensor such as a time-of-flight (ToF) sensor. The system may perform such monitoring of the user by using one or more electromyography sensors such as sensors 114 and 116 and/or one or more image sensors such as time-of-flight sensors such as sensor 118.

The EMG sensors are contact sensors in that EMG sensors make contact with a body part of the user. For example, EMG sensors such as sensors 114 and 116 may be respectively attached to the hands and feet of the user. For ease of illustration, two EMG sensors are shown. Other EMG sensors may also be attached to the user at various locations on the body of the user, depending on the specific implementation. For example, EMG sensors may also be attached to the head of the user, elbows of the user, torso of the user, knees of the user, etc.

The ToF sensors are non-contact sensors in that ToF sensors do not make contact with the user. In various implementations, the system utilizes sensors such as ToF sensors to measure distances that different parts of the user in the cab of the vehicle. For ease of illustration, one ToF sensor is shown. Other ToF sensors may also be positioned at various locations in the cabin. In this example implementation, ToF sensor 118 is positioned at the rear view mirror of the vehicle. ToF sensors may be positioned at other location within the cab of the vehicle. For example, ToF sensors may be attached around the steering wheel, to the rear view mirrors, to the doors, to the ceiling, in the foot well of the driver, in one or more other foot wells, etc., depending on the implementation.

The number of EMG sensors and ToF sensors used may vary, depending on the particular implementation. For example, while one EMG sensor 114 and two ToF sensors 116 and 118 are shown, these sensors may represent any number of EMG sensors and ToF sensors, depending on the particular implementation.

In various implementations, the in-cabin sensors 114, 116, and 118 monitor the condition of the user, and may also monitor condition of other vehicle occupants. For example, the system may monitor facial expressions and gestures to determine the driver's level of concentration and fatigue, etc. As indicated herein, the system utilizes in-cabin sensors such as EMG sensors and/or ToF sensors for both simulated and real driving scenarios. In various implementations, the system synchronizes data from one or more in-cabin images of the user, data including personalization parameters detected by one or more EMG sensors, and data from one or more ToF sensors. In some implementations, the system may process computations performed by some in-cabin sensors. In various implementations, the system processes such data described herein to detect key human behavior of the user. The system may also process such data for user personalization, driver training, road warnings, etc.

Although implementations disclosed herein are described in the context of a car, the implementations may also apply to other types of vehicles (e.g., trucks, sport utility vehicles, etc.), as well as other modes of transportation such as water vehicles (e.g., boats, etc.) and air vehicles (e.g., planes, drones, etc.). In some implementations, the vehicle is an electric vehicle. In some implementations, the vehicle is a gas-powered vehicle. In some implementations, the vehicle is a hybrid vehicle.

In various implementations, simulation environment 100 may not have all of the components shown and/or may have other elements including other types of elements instead of, or in addition to, those shown herein. Such variations also apply to other figures described herein.

While system 102 performs implementations described herein, in other implementations, any suitable component or combination of components associated with system 102 or any suitable processor or processors associated with system 102 may facilitate performing the implementations described herein.

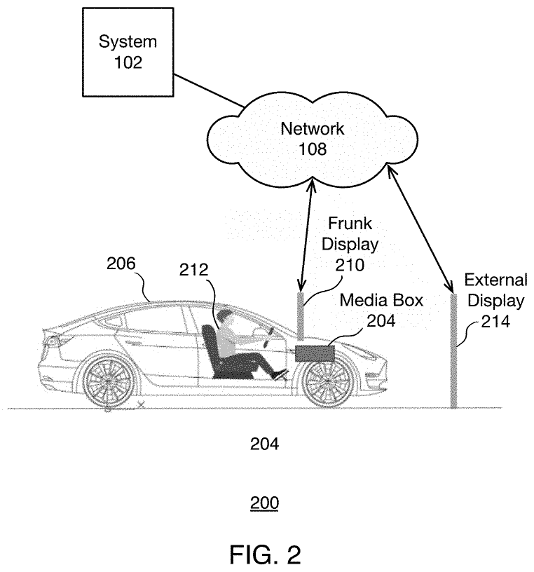

FIG. 2 is a block diagram of an example simulation environment 200 for providing a hyper realistic drive simulation, which may be used for implementations described herein. In various implementations, simulation environment 100 includes system 102 and network 108. Also shown are a media box 204 of a vehicle 206. In various implementations, media box 204 may be implemented as an in-vehicle infotainment (IVI) system. In various implementations, media box 204 may operate with a head unit (H/U) worn by the user. Media box 204 is configured to be stored in the frunk of vehicle 206. In various implementations, media box 204 is not limited to storage in the frunk and alternatively may be positioned anywhere in the vehicle. In some implementations, media box 204 be integrated with a frunk display. System 102 communicates with media box 204 via network 108, which may be any suitable communication network or combination of networks such as a Bluetooth network, a Wi-Fi network, the Internet, a 5G or 6G+ network, a satellite constellation network, etc. Also shown is a frunk display 210 positioned in front of a user 212 seated in vehicle 206.

In this example implementation, simulation environment 200 also includes another external display 214. Similar to frunk display 210, external display 214 may also receive a video stream from system 102. System 102 may send video streams to both frunk display 210 and external display 214 directly or via media box 204. The video stream shows virtual scenery as vehicle 206 virtually travels along a driving route or driving track.

In various implementations, system 102 may send or downstream simulation data to media box 204, and/or to an IVI H/U associated with media box 204, and/or to frunk display 210, and/or to external display 214 (optionally with an external media box). Also, system 102 may receive or upstream behavior analytics data including UI data, sensor data, video data, audio data, and metadata from media box 204. In various implementations, a video cast may be sent from IVI H/U or media box 204 to external display 214 (optionally with an external media box). Audio and video synchronization may be managed by media box 204 and/or IVI H/U.

In some implementations, media box 204 may send a video cast to external display 214 for video mirroring. In some scenarios where frunk display 210 and/or media box 204 is not available, the system may send the video stream directly to external display 214 and/or to an IVI H/U.

Frunk display 210 and external display 214 may display the same content or information. In various implementations, the pixel density of frunk display 210 and brightness of external display 214 are sufficient to maintain a minimum level of reality (e.g., more realistic driving experience, etc.). Also, in various implementations, the system adjusts the angle or perspective of the content displayed for both frunk display 210 and external display 214 independently. This facilitates system 102 in simulating a “horizontal level” as the user would expect.

In some implementations, display 214 may be a wall mounted display having sensors for signal processing. System 102 may utilize a sensor on the vehicle and on and/or around display 214. System 102 may then detect the distance between the vehicle and display 214. The sensor on the vehicle may be located at various locations. System 102 may then ascertain the distance between the front of the vehicle and the display 214. The system may then provide parking assistance to the user or even automate parking for the user. In some implementations, the system may display parking assist information on display 214 (e.g., green light for approaching, yellow light for slowing to stop, red light for stopping, etc.).

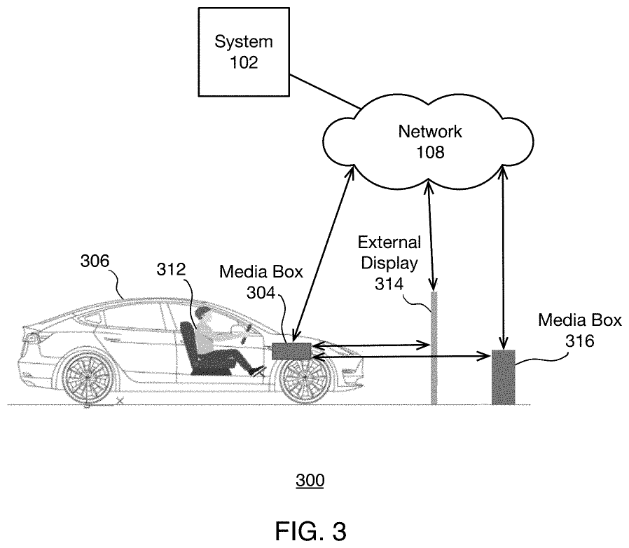

FIG. 3 is a block diagram of an example simulation environment 300 for providing a hyper realistic drive simulation, which may be used for implementations described herein. In various implementations, simulation environment 300 includes system 102 and network 108. Also shown are a media box 304 of a vehicle 306. In various implementations, media box 304 may be implemented as an IVI system. In various implementations, media box 304 may operate with a H/U. In some implementations, the H/U may be worn regardless the original equipment manufacturer (OEM), installer, user, etc. Media box 304 is configured to be stored in the frunk of vehicle 306. In various implementations, media box 304 is not limited to storage in the frunk and alternatively may be positioned anywhere in the vehicle. In some implementations, media box 304 may be integrated with a frunk display. In some implementations, media box 304 may be integrated with external display 314.

System 102 communicates with media box 304 via network 108, which may be any suitable communication network or combination of networks such as a Bluetooth network, a Wi-Fi network, the Internet, a 5G or 6G+ network, a satellite constellation network, etc. Also shown is a user 312 seated in vehicle 306 and an external display 314 positioned in front of user 312.

Similar to frunk displays 110 and 210 of respective FIGS. 1 and 2, external display 314 may also receive a video stream from system 102. System 102 may send video streams to external display 314 directly or via media box 304. The video stream includes both video and audio, and external display 314 shows virtual scenery as vehicle 306 virtually travels along a driving route or driving track. In this example implementation, simulation environment 300 includes another media box 316. In various implementations, media box 316 may provide functions that supplement the functions of media box 304. For example, media box 316 may be a video game device or console such as a PlayStation™ 5 (PS5). In various implementations, media box 316 may be integrated with external display 314.

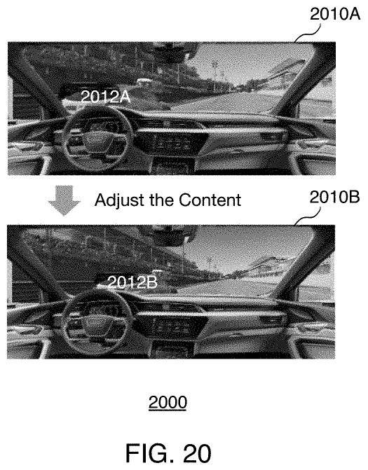

System 102 may send or downstream simulation data to media box 304, to an IVI H/U associated with media box 304 and/or to external display 314 (optionally via media box 316). In various implementations, Bluetooth may be used for local transmission of data. Also, system 102 may receive or upstream behavior analytics data including UI data, sensor data, video data, audio data, and metadata from media box 304. In some implementations, where media box 316 is a stand alone box as shown in FIG. 3, media box 316 may receive simulation data including user interface information from system 102 and/or from media box 304. As such, the system may reproduce the simulation driving on external display 314 utilizing media box 316. Once media box 316 receives certain simulation data, media box 316 may perform edge computing and perform behavior data analytics associated with the user during the simulation. In some implementations, where functionality of media box 316 complements or cooperates with media box 304, both media boxes 304 and 316 may share edge computing resources, share simulation data and perform behavior data analytics, etc. In various implementations, media box 316 may provide dedicated functionality such as facilitating with implementations described herein, such as functionalities described in connection with FIG. 20, for example. In some implementations, if the IVI H/U associated with media box 304 has Bluetooth capability, the system may enable stereo audio streaming to be sent from external media box 316 to the IVI H/U associated with media box 304 via Bluetooth.

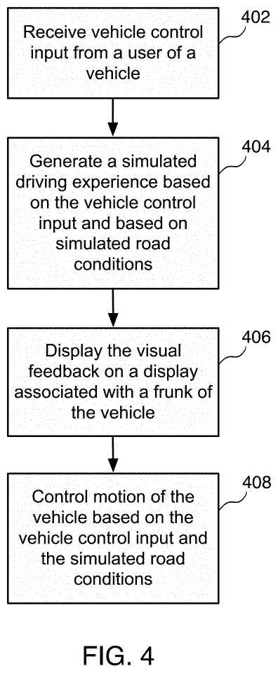

FIG. 4 is an example flow diagram for providing a hyper realistic simulated driving experience, according to some implementations. Referring to both FIGS. 1 and 2, a method is initiated at block 402, where a system such as system 102 receives vehicle control input from a user of a vehicle. In various implementations, the vehicle control input is based on user interaction with vehicle controls of the vehicle.

In various implementations, the vehicle remains parked during the simulated driving experience. This enables a user to sit in an actual vehicle while parked, yet manipulate vehicle controls to simulate driving. In various implementations, the system causes a road and/or scenery to be displayed on the frunk display. The rendered road and scenery changes as the user interacts with the vehicle controls (e.g., turning the steering wheel, stepping on the accelerator, stepping on the breaks, etc.

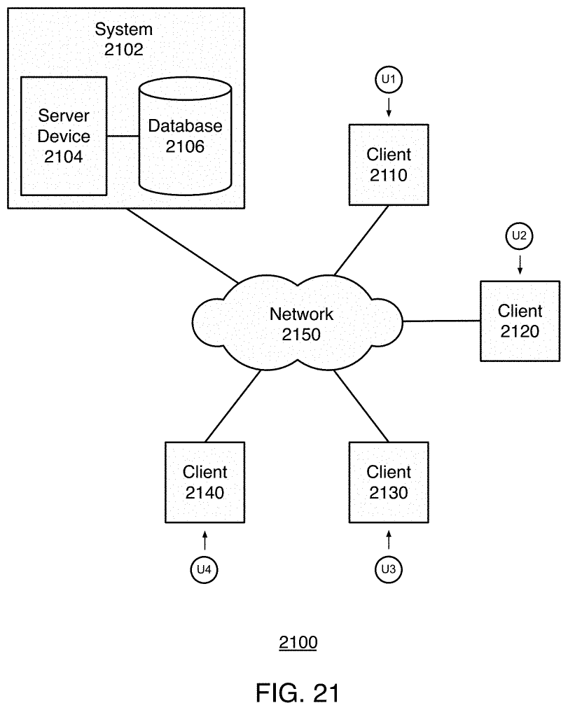

The system may store road or track information, as well as road condition information locally or remotely in a suitable database (e.g., database 2106 of FIG. 21 below). As such, implementations provide limitless road or track options as they are based on recordings of actual, real roads and environments. The system may utilize such information for virtual driving or drive simulations. For example, the system may recreate a real environment and road, yet virtually on the frunk display. As described in more detail herein, to add to the realistic simulated driving experience, the system may also control up and down movement and tilt movement of the chassis of the vehicle based on the recreated environment and road. For example, if a real road is bumpy on a portion of the road, the system may cause the chassis of the vehicle to move up and down according to recorded movement on the actual road.

The system may utilize implementations described herein to enable virtual “family vacation trips.” For example, a family member (e.g., grandmother, etc.) can join the rest of the family and experience the same drive remotely, all from her vehicle parked safely in her garage.

At block 404, the system generates a simulated driving experience based on the vehicle control input and based on simulated road conditions. In various implementations, the simulated driving experience includes visual feedback and motion feedback. The phrases “simulated driving experience,” “driving experience simulation,” and “driving simulation” may be used interchangeably. The system may store the vehicle control information and road condition information locally or remotely in a suitable database (e.g., database 2106 of FIG. 21 below).

In various implementations, the system may utilize multiple cameras and microphones mounted to the exterior of the vehicle to record video and audio. The system may record vehicle parameters (e.g., accelerator pedal motion and positions, brake pedal motion and positions, steering wheel motion and positions, active suspension parameters such as positions of each wheel, chassis angle, audio recordings, video recordings, vehicle position including global positioning system data, etc.). The particular trip parameters may vary, depending on the particular implementation. For example, the system may record actual audio and/or video of the surrounding environment before the simulation as the user is actually driving the vehicle. Also, the system may collect and record the data with timestamps and metadata in a standardized format that makes it possible to “play back” the trip at a later time.

In some implementations, the system may detect and record real time data from the content, and control the climate system and vibration of touched parts such as the steering wheel, seat, arm rest, shift knob, etc. The system may later utilize the recorded data to recreate a hyper realistic interactive simulated drive for both content and reproduction purposes.

In various implementations, the system generates simulated road conditions from the trip parameters and environment information. In some implementations, the trip parameters may include suspension data, vibration data, and angular data (e.g., horizontal level, pitch/yaw/roll, etc.), sound data (road noise, etc.), etc. In some implementations, the environment information may include temperature data, lighting data (e.g., sun light brightness, time of day, weather data, night illumination), sound data (e.g., wind noise, traffic noise, etc.), distance data (e.g., distance from other cars, etc.), parallax control data, etc.

In some implementations, the system collects trip parameters and environment information based on a variety of inputs. Such inputs may include video footage from video cameras, environmental information from sensors such a thermometers, barometers, etc. The types inputs may vary, depending on the particular implementation. In some scenarios, the vehicle may have a movement that is more than the active suspension can move. The system may capture a video recording using a camera on the vehicle. The camera may have a stabilizer for signal processing. If an angles parameter is utilized during simulation, the system may adjust and match the simulated movement to the real movement of the vehicle based on the video recording.

In another example, the system may use a lighting parameter for in-cabin lighting and/or external lighting control. Also, the system may reproduce various noises (e.g., road noise, wind noise, traffic noise, etc.) using an audio system. Such parameters may be utilized to realize the hyper realistic driving simulation. A benefit such implementations is that the system may adjust various feedback (e.g., noise level, voice level, active suspension movement, etc. during the simulated driving experience.

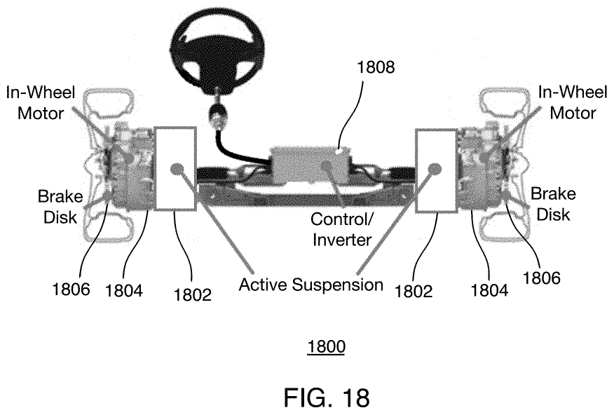

At block 406, the system displays the visual feedback on a display associated with a frunk of the vehicle. As indicated herein, in various implementations, the display is stored in the frunk of the vehicle when the display is in a retracted position. Also, in various implementations, the display is positioned in front of the user when the display is in a protracted position. While the recorded visuals may be displayed on the frunk display, any recorded audio may be rendered by the in-cabin speakers. As described in more detail herein, the system dynamically controls the motion of the chassis of the vehicle by raising/lowering the actuators embedded in the active suspension based on recorded data. Example implementations directed to the active suspension are described herein in connection with FIG. 18, for example.

At block 408, the system controls the motion of the vehicle based on the vehicle control input and the simulated road conditions. In various implementations, the system records trip parameters and environment information using sensors and cameras.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

In various implementations, the system monitors one or more actions of the user during the driving simulation. The actions of the user are observed actions. These observed actions may include observed (e.g., logged) vehicle control input from a user of a vehicle and/or movements of the user captured by video camera. The system may utilize such observed actions to facilitate as well as to enhance the simulated driving experience.

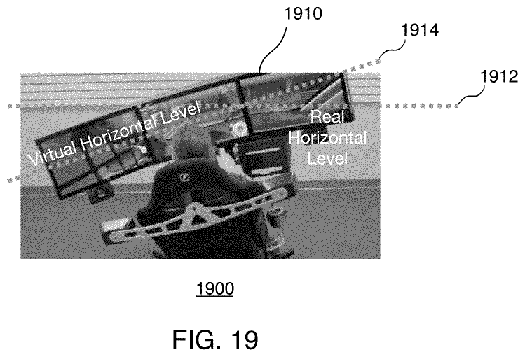

In various implementations, the system detects head movements of the user using intelligent in-cabin sensors including cameras to control the parallax of the content on the display to make it appear more realistic. Parallax may be defined as a displacement or difference in the apparent position of an object viewed along two different lines of sight. Parallax may be measured by the angle or semi-angle of inclination between those two lines. In various implementations, the system follows and observes the movement of the vehicle body and the head movement of the user using intelligent in-cabin sensors. In some implementations, the system may control the parallax of the content on the display to make it appear more realistic. For example, when the user's body moves, the user's head also moves to keep the horizontal level. Further example implementations directed to a real horizontal level versus a virtual horizontal level are described in more detail herein, in connection with FIG. 19. In some implementations, the system may adjust the height and force adjustment of the brake pedal based on the data collected on the user. For example, the brake pedal height may initially relatively higher than gas pedal in order to reduce the risk of the user inadvertently stepping on the gas before stepping on the break. In various implementations, the system may adjust the height and force adjustment of the brake pedal to the user. As such, the system accommodates different types of users (e.g., female, male, young, old, short, tall, etc.) during the simulated driving experience.

In various implementations, the system may provide real-time feedback to the user and/or may record information for feedback to the user for providing future feedback. The system analyzes the one or more actions of the user, and provides feedback to the user based on the analyzing.

In various implementations, the system provides feedback to the user to facilitate the user in improving safe driving practices. For example, the system may be aware of particular dangerous intersections with an unusually high number of accidents, which may involve injuries and/or deaths. The system may train the user to evade potential accidents based on statistical data, observations of the user, driving records, the actual simulation, etc. In some implementations, when the user is actually driving, the system may warn the user about particular intersections or driving locations that may be dangerous based on the simulation training.

In various implementations, the system provides personalized vehicle controls to the user based on one or more actions of the user during the simulated driving experience.

In various implementations, the system may also provide feedback to an advanced driver assistance system (ADAS) based on the analyzing. An ADAS may involve electronic technologies that assist drivers in driving and parking functions. Such assistance improves car and road safety.

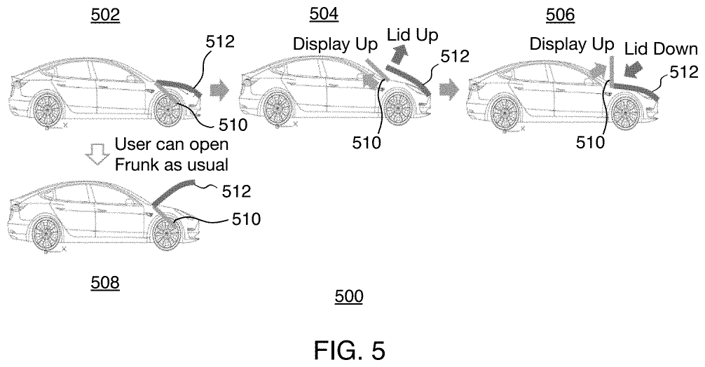

FIG. 5 is a side-view diagram 500 showing example states of a frunk display, according to some implementations. Shown are four states 502, 504, 506, and 508. In various implementations, the frunk display is stored in the frunk of the vehicle when the display is in a retracted position. For example, in a state 502, a frunk display 510 is stored in a contracted state or position in the frunk of the vehicle underneath a lid or hood 512 in a closed position.

In a state 504, hood 512 is up, and frunk display 510 is slid out and partially up. As shown, hood 512 is hinged toward the front of vehicle such that the rear side of hood 512 lifts up.

In various implementations, frunk display 510 is positioned in front of the user when the display is in a protracted position. As shown, frunk display 510 is configured to slide out toward the front windshield of the vehicle.

In a state 506, hood 512 is down. As shown, frunk display 510 is up in a protracted state or position. In various implementations, frunk display 510 is attached to the vehicle using any suitable mechanisms such that frunk display 510 is substantially vertical. As shown, frunk display 510 is positioned on the exterior of the vehicle and in front of the front windshield of the vehicle. As a result, frunk display 510 is positioned in front a user or users sitting in the vehicle. The user(s) may then view a simulated driving environment on frunk display 510 as if actually driving on a road or track.

In state 508, hood 512 is up and frunk display 510 in a contracted position in the frunk of the vehicle. As shown, hood 512 is also hinged toward the rear of the vehicle such that the front side of hood 512 lifts up for normal storage usage. This enables frunk display 510 and personal items be stored in the frunk.

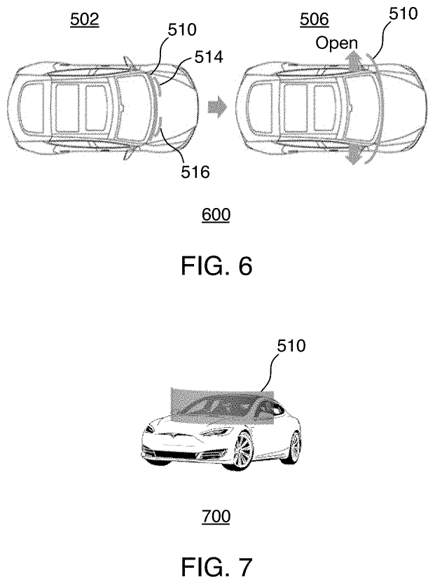

FIG. 6 is a top-view diagram 600 showing example states of frunk display 510 of FIG. 5, according to some implementations. In state 502, frunk display 510 is in a contracted position, where two outer portions 514 and 516 are slid toward one another over the main body of frunk display 510. This contracted position enables frunk display 510 to be stored in the frunk of the vehicle.

In state 506, frunk display 510 is in a protracted position, where two outer portions 514 and 516 are slid open and outward away from one another. This expands frunk display 510 to the protracted position.

FIG. 7 is a perspective-view diagram 700 showing example states of the frunk display of FIGS. 5 and 6, according to some implementations. As shown, frunk display 510 in the protracted position. As indicated herein, this enables a user or users sitting in the vehicle to view a simulated driving environment on frunk display 510 as if actually driving on a road or track.

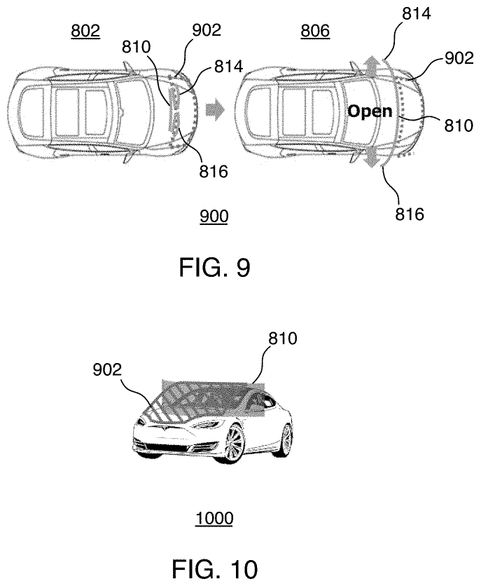

In various implementations, frunk display 510 expands when the display is in the protracted position such that the width of the display is greater than a front windshield of the vehicle. Examples are shown in FIGS. 6 and 7, as well as in FIGS. 9 and 10 below, for example. This facilitates the system in providing a virtual yet realistic driving experience for the user, because it enables the user to view the virtual scenery through all or most points of view through the front windshield.

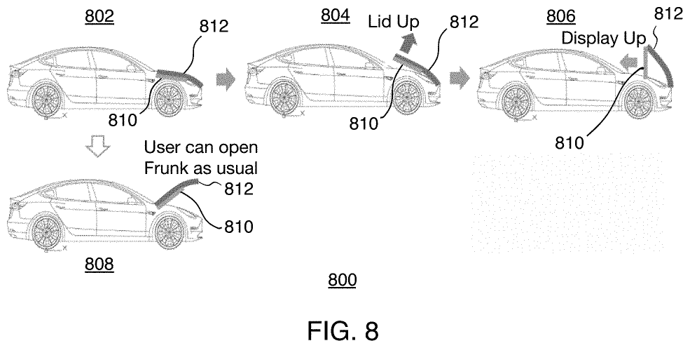

FIG. 8 is a side-view diagram 800 showing example states of a frunk display, according to some implementations. Shown are four states 802, 804, 806, and 808. In state 802, a frunk display 810 is stored in a contracted state or position in the frunk of the vehicle underneath a lid or hood 812 in a closed position.

In state 804, hood 812 is partially up, and frunk display 810 is attached underneath hood 812. In the example, frunk display 810 remains in a contracted position. In some implementations, while hood 812 is in a partially up position, frunk display 810 may partially protract as hood 812 opens.

In state 806, hood 812 is up. As shown, frunk display 810 is up in a protracted state or position. In various implementations, frunk display 810 is attached to the front hood of the vehicle when the display is in the retracted position and in the protracted position. For example, as shown, frunk display 810 is hinged at the top and coupled to hood 812 by one or more hinges (not shown). Hood 812 is also hinged toward the front of vehicle such that the rear side of hood 812 lifts up. This enables frunk display 810 to fold out toward the front windshield of the vehicle.

In various implementations, frunk display 810 is attached to hood 812 by one or more hinges as indicted above. The bottom portion of frunk display 810 may couple to the vehicle using any suitable mechanisms such that frunk display 810 is substantially vertical. As shown, frunk display 810 is positioned on the exterior of the vehicle and in front of the front windshield of the vehicle. As a result, frunk display 810 is positioned in front a user or users sitting in the vehicle. The user(s) may then view a simulated driving environment on frunk display 810 as if actually driving on a road or track.

In state 808, hood 812 is up and frunk display 810 in a contracted position coupled to the underside of hood 812. As shown, hood 812 is also hinged toward the rear of the vehicle such that the front side of hood 812 lifts up for normal storage usage. This enables frunk display 810 and personal items be stored in the frunk, as shown.

FIG. 9 is a top-view diagram 900 showing example states of the frunk display of FIG. 8, according to some implementations. In state 802, frunk display 810 is in a contracted position, where two outer portions 814 and 816 are folded toward one another over the main body of frunk display 810. This contracted position enables frunk display 810 to be stored in the frunk of the vehicle. The dotted portion 902 may represent the frunk hood.

In state 806, frunk display 810 is in a protracted position, where two outer portions 814 and 816 are folded open and outward away from one another. This expands frunk display 810 to the protracted position.

FIG. 10 is a perspective-view diagram 1000 showing example states of the frunk display of FIGS. 8 and 9, according to some implementations. As shown, frunk display 810 in the protracted position. As indicated herein, this enables a user or users sitting in the vehicle to view a simulated driving environment on frunk display 810 as if actually driving on a road or track. The striped portion 902 may represent the frunk hood.

While some implementations are described herein in the context of frunk displays that slide or fold into a contracted position, other contraction techniques are possible, depending on the implementation. For example, in some implementations, a frunk display may roll into a contracted position.

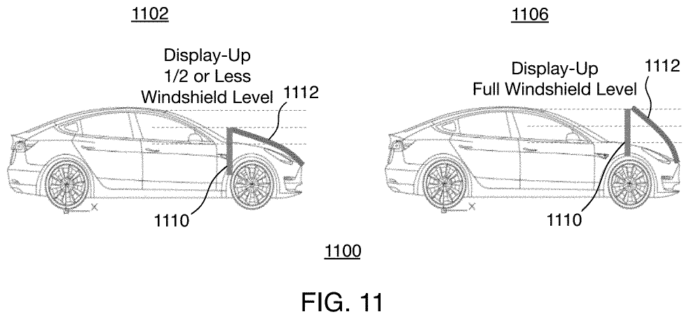

FIG. 11 is a side-view diagram 1100 showing example states of a frunk display, according to some implementations. Shown are a frunk display 1110 coupled to a hood 1112 of a vehicle. In various implementations, frunk display 1110 expands when the display is in the protracted position such that the height of the display is adjustable.

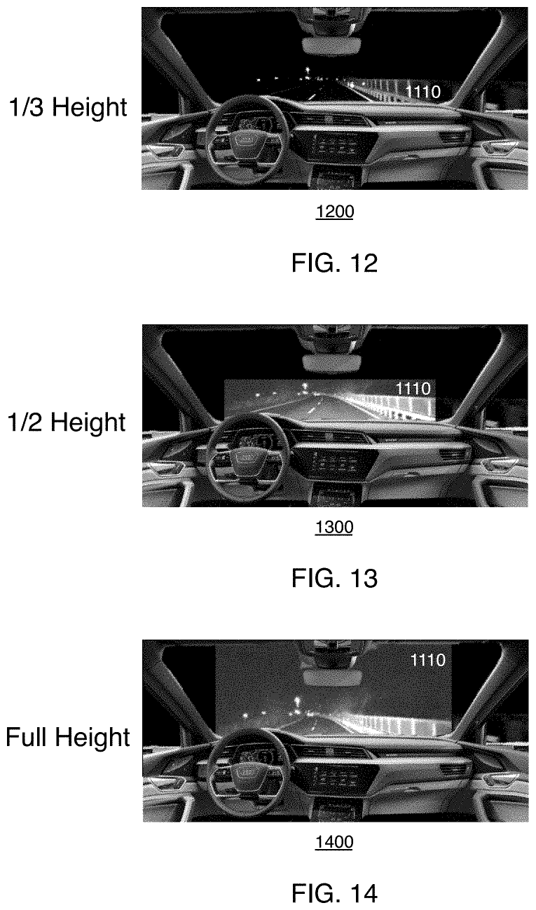

In a state 1102, hood 1112 is ⅓ of the way open. Hood 1112 is coupled to frunk display 1110 by one or more hinges (not shown). In a state 1106, hood 1112 is ½ of the way open. The dotted lines correspond to different example heights of frunk display 1110. As shown, hood 1112 is coupled to the top of frunk display 1110 by one or more hinges (not shown). This enables frunk display 1110 to remain substantially vertical at different heights as hood 1112 opens and closes. Further example implementations of frunk display 1110 are described in more detail herein, in connection with FIGS. 12, 13, 14, and 15, for example.

FIG. 12 is a diagram 1200 showing the frunk display of FIG. 11 from a perspective of a user inside the cab of a vehicle, where the frunk display is at a ⅓ height, according to some implementations.

FIG. 13 is a diagram 1300 showing the frunk display of FIGS. 11 and 12 from a perspective of a user inside the cab of a vehicle, where the frunk display is at a ½ height, according to some implementations.

FIG. 14 is a diagram 1400 showing the frunk display of FIGS. 11, 12, and 13 from a perspective of a user inside the cab of a vehicle, where the frunk display is at a full height, according to some implementations. The example positions at ⅓ height, ½ height and full height may change depending on the particular implementation. In various implementations, the height of the frunk display may be adjusted to different incremental heights. In some implementations, the system may also display a rear-view mirror and side mirrors on the frunk display.

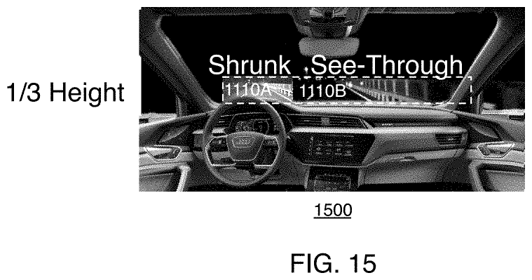

FIG. 15 is a diagram 1500 showing the frunk display of FIG. 11 from a perspective of a user inside the cab of a vehicle, where the frunk display is at a ⅓ height, and where different portions of the frunk display may serve different purposes, according to some implementations. In this example implementation, the frunk display has one portion 1110A that shows a shrunken version of the image displayed on the frunk display. Also, the frunk display has another portion 1110B that shows a normal or see-through version of the image displayed on the frunk display. The particular size and positions of portions 1110A and 1110B may vary, depending on the particular implementation. In various implementations, these features may be applied to the frunk display at different heights.

In some implementations, the see-through version may be used in vehicle that the user is actually driving. The system may utilize a high-sensitivity image sensor to enable the user to drive safely even with no street lights on the road. In some implementations, any of the frunk displays described herein may include warning messages to the user if the user of actually driving, such as “Accident!!!,” “Slow Down!!!,” “Please do shoulder check. It's real driving!,” “Please push brake pedal faster. It's real driving!,” etc.

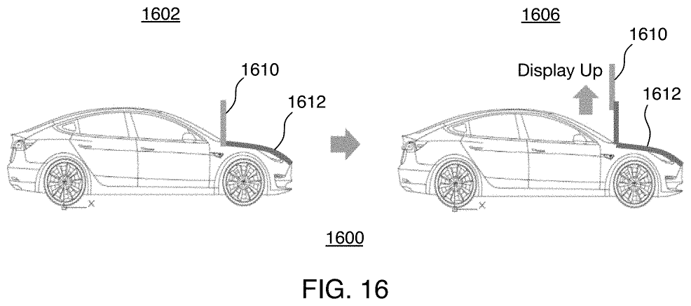

FIG. 16 is a side-view diagram 1600 showing example states of a frunk display, according to some implementations. In a state 1602, a frunk display 1610 is in a first protracted state or position. In a state 1606, a frunk display 1610 in a second protracted state or position. As shown, a hood 1612 remains in a closed position in both states 1602 and 1606. As such, the height of frunk display 1610 may be adjusted to different heights while hood 1612 remains closed. For ease of illustration, two states 1602 and 1606 are shown. In various implementations, frunk display may be adjusted to different heights.

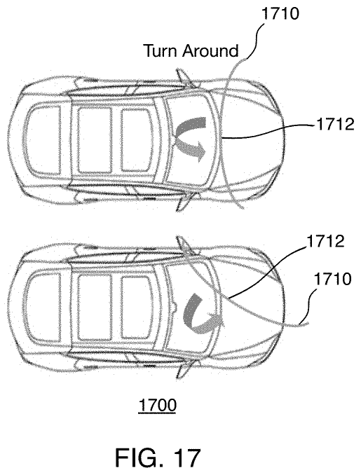

FIG. 17 is a top-view diagram 1700 showing example states of a frunk display, according to some implementations. In various implementations, the frunk display 1710 is configurable to roll and/or rotate when the display is in the protracted position. For example, in various implementations, frunk display 1710 may roll and/or rotate along an axis 1712. In various implementations, the system may automatically roll and/or rotate frunk display 1710 without user intervention such that the scenery displayed on frunk display 1710 represents what the user would see while actually driving the vehicle. While some example are described in the context of rolls or rotations, the system may also cause frunk display 1710 to pan and/or tilt in addition to rolling and rotating. In some implementations, the system may perform signal processing for brightness control, for detection of surrounding environmental brightness, for horizontal level control, and for detecting the parking location angle of the vehicle.

FIG. 18 is a diagram showing example components 1800 of a vehicle, according to some implementations. As shown, components 1800 include a pair of active suspension units 1802, a pair of in-wheel motors 1804, break discs 1806, and a control/inverter unit 1808.

In various implementations, the system emulates the driving motion of the vehicle via the motion of active suspension. In other words, the motion of the vehicle includes the motion of the active suspension of the vehicle. Active suspension works by controlling the softness of the dampers electrically to realize the active shock absorbing suspension system. Controlling the dampers, possibly in combination with added actuators would enable a way for the system to emulate real driving/road conditions while the car is parked. In various implementations, active suspension units 1802 provide such motion of the overall suspension. For example, in various implementations, active suspension units 1802 change the height and tilt of the chassis of the vehicle.

In some implementations, active suspension units 1802 control horizontal level movement of the chassis of the vehicle. In various implementations, the horizontal level movement is based on movement of dampers (e.g., shock absorbers) of the vehicle. In some implementations, the system may also utilize actuators in combination with the dampers in controlling the horizontal level movement of the chassis. Controlling the dampers in combination with added actuators enables a way to emulate real driving with realistic seeming road conditions while the car is parked. As such, active suspension units 1802 in combination of other components 1800 of the vehicle facilitate the system in providing the user with a realistic simulated driving experience.

FIG. 19 is a diagram 1900 showing example orientations a frunk display, according to some implementations. The implementations described herein in connection with FIG. 19 may also apply to an external display such as external displays 214 and 314 of respective FIGS. 2 and 3. Shown is real horizontal level 1912 indicated with dotted lines, and virtual horizontal level 1914 also indicated with dotted lines. In various implementations, during the drive simulation, if the user turns the steering wheel to the left, the system causes the active suspension of the vehicle to cause the entire chassis of the vehicle to tilt to the left. Conversely, if the user turns the steering wheel to the right, the system causes the active suspension of the vehicle to cause the entire chassis of the vehicle to tilt to the right. The system causes the degree of the tilt to be proportional to the amount that the steering wheel is being turned by the user and the virtual speed of the vehicle. The speed of the vehicle may be based on a combination of the user manipulating different vehicle controls (e.g., accelerator, breaks, etc.). For example, the higher the virtual speed (higher centrifugal force) and/or the more the steering wheel is turned causes the angle between the real horizontal level 1912 and virtual horizontal level 1914 to increase. Conversely, the lower the virtual speed (lower centrifugal force) and/or the less the steering wheel is turned causes the angle between the real horizontal level 1912 and virtual horizontal level 1914 to decrease.

FIG. 20 is a diagram 2000 showing example changes to content shown on a frunk display, according to some implementations. In a first state, where a frunk display is labeled 2010A, an object such as a car 2012A is shown in the left-hand side of frunk display.

In various scenarios, the positions of virtual objects in the screen relative to the vehicle and the viewpoint of the user in a drive simulation scenario may differ from the positions of real objects in a real driving scenario. In various implementations, the system may cause one or more virtual objects to be moved or shifted within the scene that is displayed on the frunk display. For example, in a second state, where a frunk display is labeled 2010B, the same object or car (labeled 2012B) is shown as moved or shifted over to the right toward the middle of frunk display 2010B.

In some implementations, the system may use a sensor in the cabin of the vehicle to detect the user's head position and seat position. The system may also determine and/or store the dimensions of the vehicle, the parking position of the car, etc., and adjust the content displayed on the frunk display. The system may then shift a given object to a realistic position, as described above. The system may also scale the objects depicted in the frunk display to a realistic size.

The drive simulation described herein has various applications. For example, the drive simulation may be used for realistic drive training purposes. The drive simulation may also be used as a sales tool to take a drive in the actual car without leaving the dealership. Additionally, the drive simulation may be used for virtual trips to remote places, all from the safety of being at home.

Implementations described herein provide various benefits. For example, implementations provide a hyper realistic simulated driving experience. Implementations described herein also improve drive safety by enabling personalization and realistic drive simulation in actual vehicle while the car is parked.

FIG. 21 is a block diagram of an example network environment 2100, which may be used for some implementations described herein. In some implementations, network environment 2100 includes a system 2102, which includes a server device 2104 and a database 2106. For example, system 2102 may be used to implement system 102 of FIG. 1, as well as to perform implementations described herein. Network environment 2100 also includes client devices 2110, 2120, 2130, and 2140, which may communicate with system 2102 and/or may communicate with each other directly or via system 2102. Network environment 2100 also includes a network 2150 through which system 2102 and client devices 2110, 2120, 2130, and 2140 communicate. Network 2150 may be any suitable communication network such as a Wi-Fi network, Bluetooth network, the Internet, a 5G or 6G+ network, a satellite constellation network, etc.

For ease of illustration, FIG. 21 shows one block for each of system 2102, server device 2104, and network database 2106, and shows four blocks for client devices 2110, 2120, 2130, and 2140. Blocks 2102, 2104, and 2106 may represent multiple systems, server devices, and network databases. Also, there may be any number of client devices. In other implementations, environment 2100 may not have all of the components shown and/or may have other elements including other types of elements instead of, or in addition to, those shown herein.

While server device 2104 of system 2102 performs implementations described herein, in other implementations, any suitable component or combination of components associated with system 2102 or any suitable processor or processors associated with system 2102 may facilitate performing the implementations described herein.

In the various implementations described herein, a processor of system 2102 and/or a processor of any client device 2110, 2120, 2130, and 2140 cause the elements described herein (e.g., information, etc.) to be displayed in a user interface on one or more display screens.

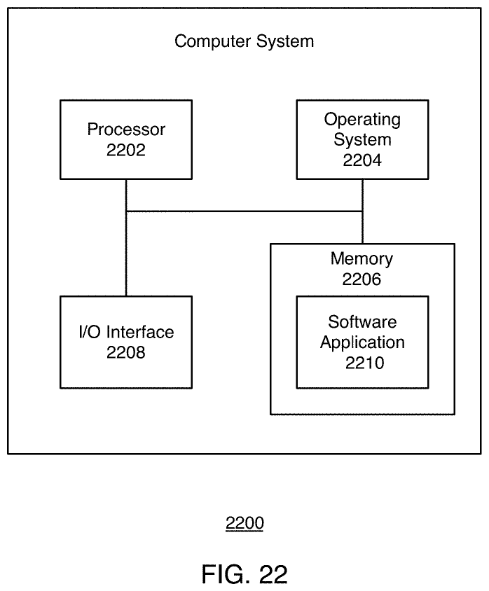

FIG. 22 is a block diagram of an example computer system 2200, which may be used for some implementations described herein. For example, computer system 2200 may be used to implement server device 2104 of FIG. 21 and/or system 102 of FIG. 1, as well as to perform implementations described herein. In some implementations, computer system 2200 may include a processor 2202, an operating system 2204, a memory 2206, and an input/output (I/O) interface 2208. In various implementations, processor 2202 may be used to implement various functions and features described herein, as well as to perform the method implementations described herein. While processor 2202 is described as performing implementations described herein, any suitable component or combination of components of computer system 2200 or any suitable processor or processors associated with computer system 2200 or any suitable system may perform the steps described. Implementations described herein may be carried out on a user device, on a server, or a combination of both.

Computer system 2200 also includes a software application 2210, which may be stored on memory 2206 or on any other suitable storage location or computer-readable medium. Software application 2210 provides instructions that enable processor 2202 to perform the implementations described herein and other functions. Software application may also include an engine such as a network engine for performing various functions associated with one or more networks and network communications. The components of computer system 2200 may be implemented by one or more processors or any combination of hardware devices, as well as any combination of hardware, software, firmware, etc.

For ease of illustration, FIG. 22 shows one block for each of processor 2202, operating system 2204, memory 2206, I/O interface 2208, and software application 2210. These blocks 2202, 2204, 2206, 2208, and 2210 may represent multiple processors, operating systems, memories, I/O interfaces, and software applications. In various implementations, computer system 2200 may not have all of the components shown and/or may have other elements including other types of components instead of, or in addition to, those shown herein.

Although the description has been described with respect to particular implementations thereof, these particular implementations are merely illustrative, and not restrictive. Concepts illustrated in the examples may be applied to other examples and implementations.

In various implementations, software is encoded in one or more non-transitory computer-readable media for execution by one or more processors. The software when executed by one or more processors is operable to perform the implementations described herein and other functions.

Any suitable programming language can be used to implement the routines of particular implementations including C, C++, C#, Java, JavaScript, assembly language, etc. Different programming techniques can be employed such as procedural or object oriented. The routines can execute on a single processing device or multiple processors. Although the steps, operations, or computations may be presented in a specific order, this order may be changed in different particular implementations. In some particular implementations, multiple steps shown as sequential in this specification can be performed at the same time.

Particular implementations may be implemented in a non-transitory computer-readable storage medium (also referred to as a machine-readable storage medium) for use by or in connection with the instruction execution system, apparatus, or device. Particular implementations can be implemented in the form of control logic in software or hardware or a combination of both. The control logic when executed by one or more processors is operable to perform the implementations described herein and other functions. For example, a tangible medium such as a hardware storage device can be used to store the control logic, which can include executable instructions.

Particular implementations may be implemented by using a programmable general purpose digital computer, and/or by using application specific integrated circuits, programmable logic devices, field programmable gate arrays, optical, chemical, biological, quantum or nanoengineered systems, components and mechanisms. In general, the functions of particular implementations can be achieved by any means as is known in the art. Distributed, networked systems, components, and/or circuits can be used. Communication, or transfer, of data may be wired, wireless, or by any other means.

A “processor” may include any suitable hardware and/or software system, mechanism, or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions (e.g., program or software instructions) for execution by the processor. For example, a tangible medium such as a hardware storage device can be used to store the control logic, which can include executable instructions. The instructions can also be contained in, and provided as, an electronic signal, for example in the form of software as a service (SaaS) delivered from a server (e.g., a distributed system and/or a cloud computing system).

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular implementations have been described herein, latitudes of modification, various changes, and substitutions are intended in the foregoing disclosures, and it will be appreciated that in some instances some features of particular implementations will be employed without a corresponding use of other features without departing from the scope and spirit as set forth. Therefore, many modifications may be made to adapt a particular situation or material to the essential scope and spirit.

What is claimed is:

1. A system comprising:
a display, wherein the display is configured to be stored in a frunk of a vehicle when the display is in a retracted position, and wherein the display is configured to be positioned in front of a user when the display is in a protracted position; and
a media unit, wherein the media unit is configured to provide visual feedback to the user via the display.

2. The system of claim 1, wherein the display is positioned inside a cab of the vehicle when the display is in the protracted position.

3. The system of claim 1, wherein the display is positioned outside a cab of the vehicle when the display is in the protracted position.

4. The system of claim 1, wherein the display expands when the display is in the protracted position such that a width of the display is greater than a front windshield of the vehicle.

5. The system of claim 1, wherein the display expands when the display is in the protracted position such that a height of the display is adjustable.

6. The system of claim 1, wherein the display is attached to a front hood of the vehicle when the display is in the retracted position and in the protracted position.

7. The system of claim 1, wherein the display is configurable to rotate when the display is in the protracted position.

8. An apparatus comprising:
a display, wherein the display is configured to be stored in a frunk of a vehicle when the display is in a retracted position, and wherein the display is configured to be positioned in front of a user when the display is in a protracted position; and
a media unit, wherein the media unit is configured to provide visual feedback to the user via the display.

9. The apparatus of claim 8, wherein the display is positioned inside a cab of the vehicle when the display is in the protracted position.

10. The apparatus of claim 8, wherein the display is positioned outside a cab of the vehicle when the display is in the protracted position.

11. The apparatus of claim 8, wherein the display expands when the display is in the protracted position such that a width of the display is greater than a front windshield of the vehicle.

12. The apparatus of claim 8, wherein the display expands when the display is in the protracted position such that a height of the display is adjustable.

13. The apparatus of claim 8, wherein the display is attached to a front hood of the vehicle when the display is in the retracted position and in the protracted position.

14. The apparatus of claim 8, wherein the display is configurable to rotate when the display is in the protracted position.

15. A computer-implemented method for providing a hyper realistic simulated driving experience, the method comprising:
monitoring, at a media unit, user interaction with vehicle controls of a vehicle, wherein the media unit is configured to provide visual feedback to a user;
generating a simulated driving experience based on the user interaction with the vehicle controls and based on simulated road conditions;
displaying the visual feedback on the display, wherein the display is configured to be stored in a frunk of the vehicle when the display is in a retracted position, and wherein the display is configured to be positioned in front of a user when the display is in a protracted position; and
controlling motion of the vehicle based on the vehicle control input and the simulated road conditions.

16. The method of claim 15, wherein the display is positioned inside a cab of the vehicle when the display is in the protracted position.

17. The method of claim 15, wherein the display is positioned outside a cab of the vehicle when the display is in the protracted position.

18. The method of claim 15, wherein the display expands when the display is in the protracted position such that a width of the display is greater than a front windshield of the vehicle.

19. The method of claim 15, wherein the display expands when the display is in the protracted position such that a height of the display is adjustable.

20. The method of claim 15, wherein the display is attached to a front hood of the vehicle when the display is in the retracted position and in the protracted position.
